(19) United States
(12) Patent Application Publication
(10) Pub. No.: US 2026/0292870 A1
(43) Pub. Date: Sep. 24, 2026

(54) UPLINK SELECTION AND SWITCHING IN INITIAL ACCESS

(71) Applicant: QUALCOMM Incorporated, San Diego, CA (US)

(72) Inventors: Kangqi LIU, San Diego, CA (US); Jing LEI, San Diego, CA (US); Chao WEI, Beijing (CN)

(21) Appl. No.: 19/475,372

(22) PCT Filed: May 10, 2023
(86) PCT No.: PCT/CN2023/093184

§ 371 Date: Oct. 14, 2025

(51) Int. Cl. H04W 74/00; H04W 74/0833

(52) U.S. Cl. CPC H04W 74/004; H04W 74/006; H04W 74/0833

(57) ABSTRACT

Various aspects of the present disclosure generally relate to wireless communication. In some aspects, a user equipment (UE) may receive, on a downlink carrier of a bidirectional cell having the downlink carrier and a first uplink carrier, configuration information. The UE may transmit, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range. Numerous other aspects are described.

### FIELD OF THE DISCLOSURE

Aspects of the present disclosure generally relate to wireless communication and to techniques and apparatuses for uplink selection and switching in initial access.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, on a downlink carrier of a bidirectional cell having the downlink carrier and a first uplink carrier, configuration information. The method may include transmitting, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range.

Some aspects described herein relate to a method of wireless communication performed by a network node. The method may include transmitting, on a downlink carrier of a bidirectional cell having the downlink carrier and a first uplink carrier, configuration information. The method may include receiving, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

Some aspects described herein relate to a UE for wireless communication. The UE may include one or more memories and one or more processors coupled to the one or more memories. The one or more processors may be configured to receive, on a downlink carrier of a bidirectional cell having the downlink carrier and a first uplink carrier, configuration information. The one or more processors may be configured to transmit, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

Some aspects described herein relate to a network node for wireless communication. The network node may include one or more memories and one or more processors coupled to the one or more memories. The one or more processors may be configured to transmit, on a downlink carrier of a bidirectional cell having the downlink carrier and a first uplink carrier, configuration information. The one or more processors may be configured to receive, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

Some aspects described herein relate to a non-transitory computer-readable medium that stores a set of instructions for wireless communication by a UE. The set of instructions, when executed by one or more processors of the UE, may cause the UE to receive, on a downlink carrier of a bidirectional cell having the downlink carrier and a first uplink carrier, configuration information. The set of instructions, when executed by one or more processors of the UE, may cause the UE to transmit, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

Some aspects described herein relate to a non-transitory computer-readable medium that stores a set of instructions for wireless communication by a network node. The set of instructions, when executed by one or more processors of the network node, may cause the network node to transmit, on a downlink carrier of a bidirectional cell having the downlink carrier and a first uplink carrier, configuration information. The set of instructions, when executed by one or more processors of the network node, may cause the network node to receive, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

Some aspects described herein relate to an apparatus for wireless communication. The apparatus may include means for receiving, on a downlink carrier of a bidirectional cell having the downlink carrier and a first uplink carrier, configuration information. The apparatus may include means for transmitting, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

Some aspects described herein relate to an apparatus for wireless communication. The apparatus may include means for transmitting, on a downlink carrier of a bidirectional cell having the downlink carrier and a first uplink carrier, configuration information. The apparatus may include means for receiving, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a two-step random access procedure, in accordance with the present disclosure.

FIG. 5 is a diagram illustrating an example of a four-step random access procedure, in accordance with the present disclosure.

FIGS. 6A-6C are diagrams illustrating examples of uplink-only cells, in accordance with the present disclosure.

FIGS. 7A-7F are diagrams illustrating an example associated with uplink selection and switching in initial access, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

In some communications systems, a user equipment (UE) may be configured to communicate with a network node via a plurality of uplink carriers. For example, a network node may provide a supplementary uplink or an aggregated uplink to increase a coverage area, a throughput, and/or a reliability of uplink transmissions from the UE. Supplementary uplink deployments may differ from aggregated uplink deployments by allowing a UE to be scheduled to transmit either on a supplementary uplink (e.g., an uplink carrier of a unidirectional cell) or on an uplink of a carrier being supplemented (e.g., an uplink carrier of a bidirectional cell), which may be referred to as a supplemented uplink carrier.

For initial access and/or RACH procedures on a cell configured with a supplementary uplink, a network node may explicitly indicate which uplink carrier a UE is to use for uplink communications. If the network node does not explicitly indicate an uplink carrier, the UE may select a supplemented uplink carrier as a default, selected uplink carrier. When a channel metric of the supplemented uplink carrier does not satisfy a threshold, the UE may select the supplementary uplink as the selected uplink carrier. In these examples, once a RACH procedure is started on a selected uplink carrier, all uplink transmissions of the RACH procedure remain on the selected uplink carrier. However, when an uplink quality on the selected uplink carrier is poor, statically remaining on the selected uplink carrier can result in dropped communications.

Some aspects described herein enable uplink selection and switching in initial access assisted by uplink-only cells. For example, a UE may receive configuration information on a downlink carrier of a bidirectional cell. The configuration information may include a threshold for selecting an uplink carrier or an indication of a carrier switch between a first uplink carrier and a second uplink carrier, among other examples. Based at least in part on the configuration information, the UE and a network node may exchange one or more signaling messages. In this case, the UE may transmit a first random access channel (RACH) message (or a third RACH message) to the network node on a first uplink carrier associated with a bidirectional cell or a second uplink carrier associated with a unidirectional cell. In some aspects, the UE may switch between transmitting on the first uplink carrier and transmitting on the second uplink carrier based at least in part on one or more parameters, as described below.

Various aspects relate to initial access procedures. Some aspects more specifically relate to random access channel procedures with supplementary uplink carriers. In some examples, a UE may switch between transmitting on a supplemented uplink carrier and transmitting on a supplementary uplink carrier.

Particular aspects of the subject matter described in this disclosure can be implemented to realize one or more of the following advantages. In some examples, based at least in part on the UE and the network node communicating on the first uplink carrier or the second uplink carrier, the described techniques can be used to enable the UE and the network node to complete a communication procedure, such as a RACH procedure. In this way, the UE uses a dynamically configured uplink carrier for transmission, thereby reducing a likelihood of failing to complete a communication procedure relative to statically selecting an uplink carrier.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

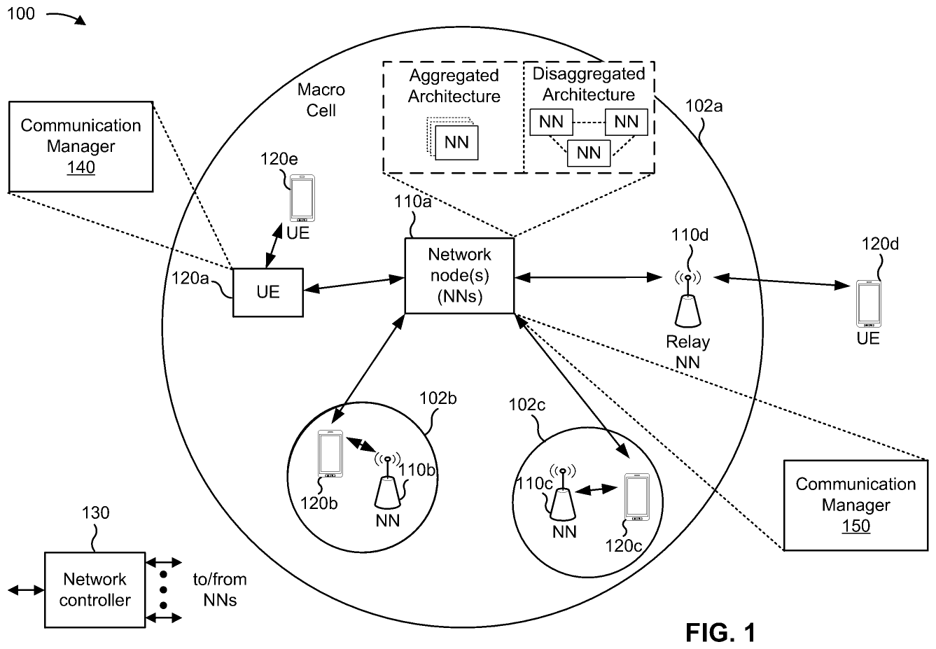

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz −7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, on a downlink carrier of a bidirectional cell having the downlink carrier and a first uplink carrier, configuration information; and transmit, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range. Additionally, or alternatively, the communication manager 140 may perform one or more other operations described herein.

In some aspects, the network node 110 may include a communication manager 150. As described in more detail elsewhere herein, the communication manager 150 may transmit, on a downlink carrier of a bidirectional cell having the downlink carrier and a first uplink carrier, configuration information; and receive, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range. Additionally, or alternatively, the communication manager 150 may perform one or more other operations described herein.

As indicated above, FIG. 1 is provided as an example. Other examples may differ from what is described with regard to FIG. 1.

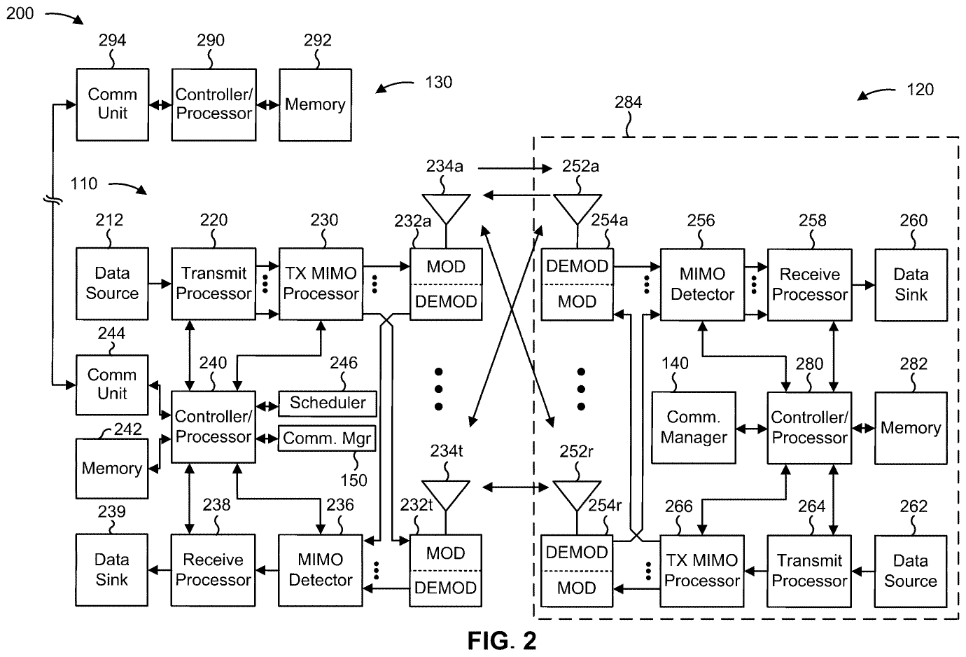

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

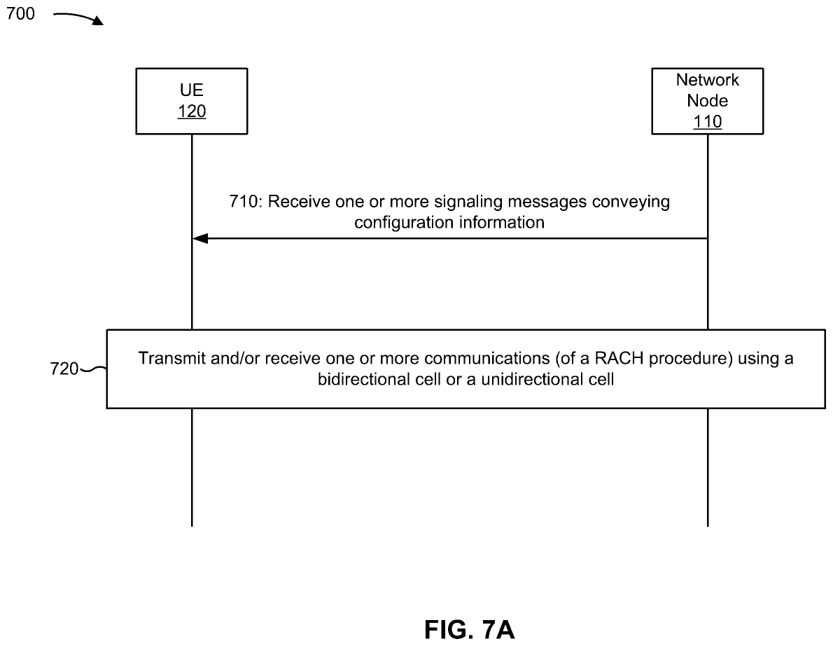

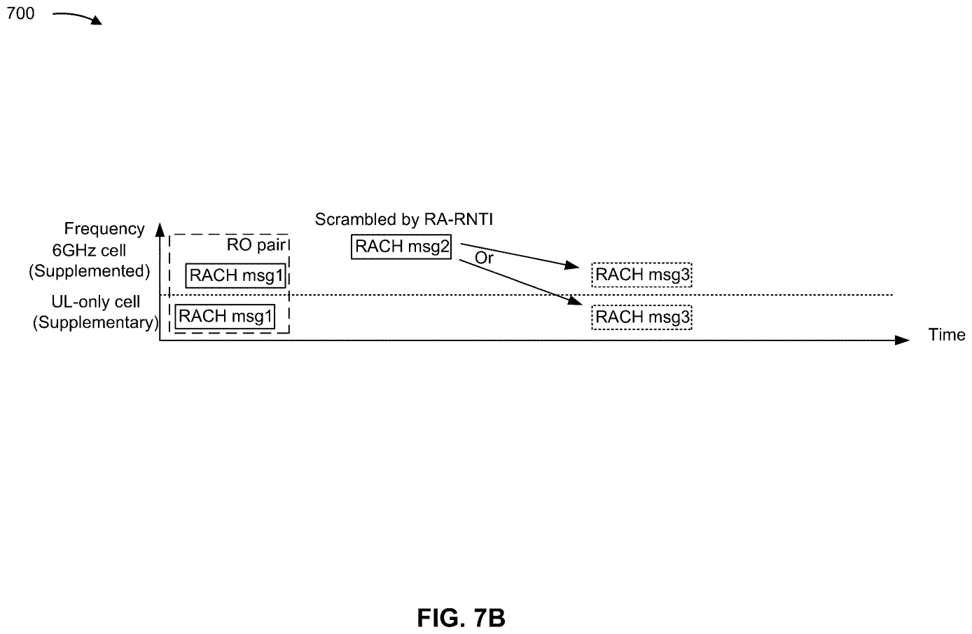

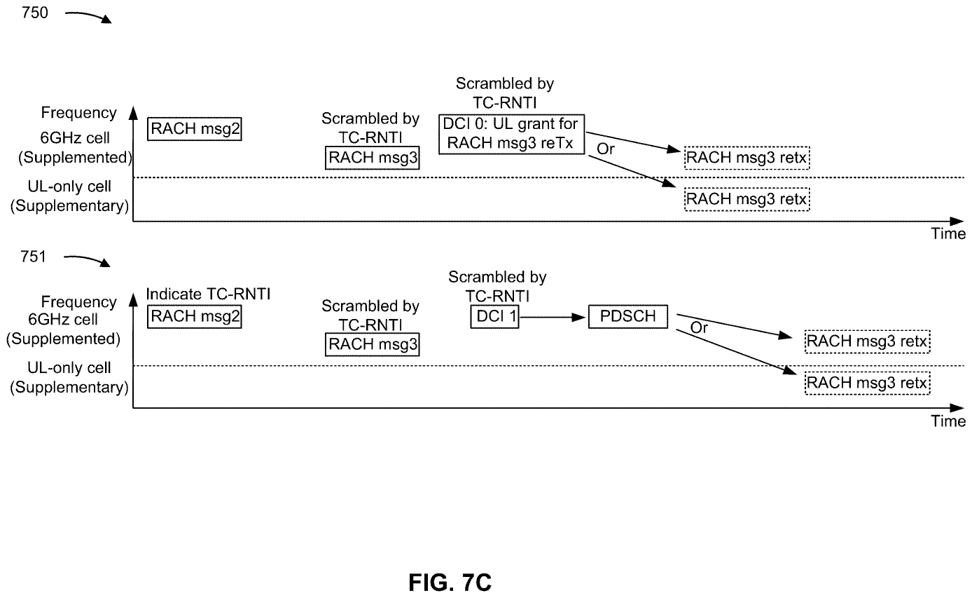

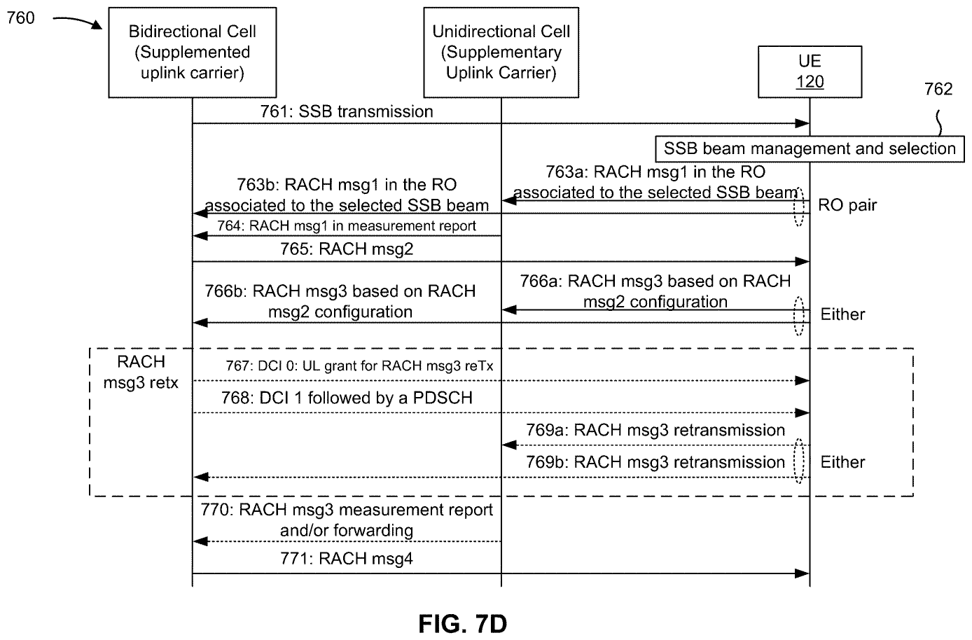

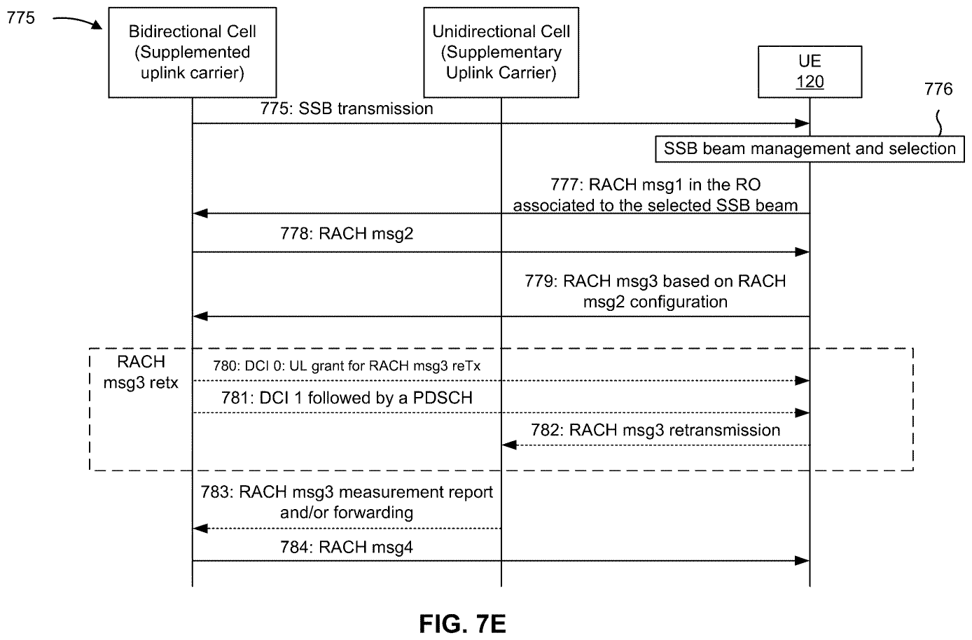

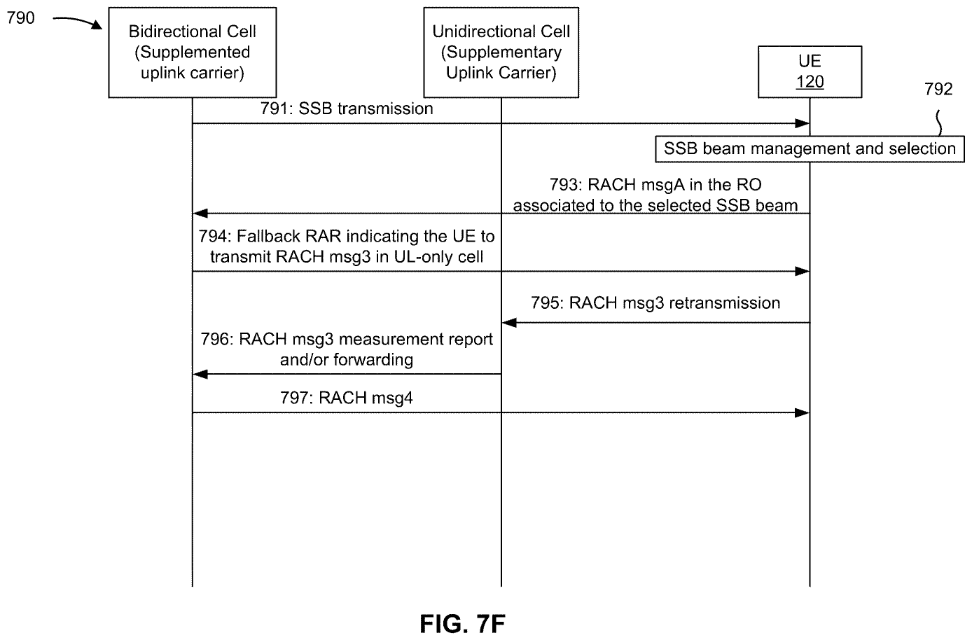

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-11).

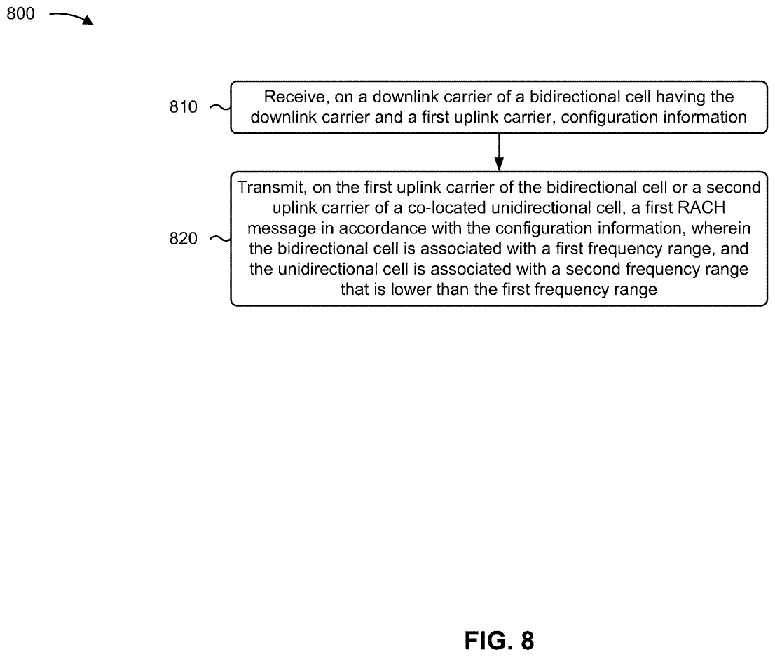

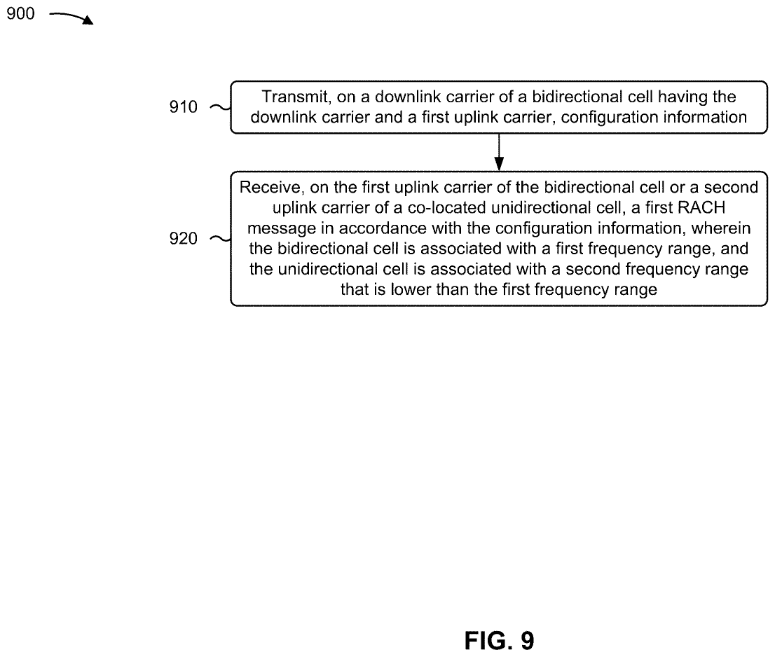

The controller/processor 240 of the network node 110, the controller/processor 280 of the UE 120, and/or any other component(s) of FIG. 2 may perform one or more techniques associated with uplink selection and switching in initial access, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, on a downlink carrier of a bidirectional cell having the downlink carrier and a first uplink carrier, configuration information; and/or means for transmitting, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, on a downlink carrier of a bidirectional cell having the downlink carrier and a first uplink carrier, configuration information; and/or means for receiving, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

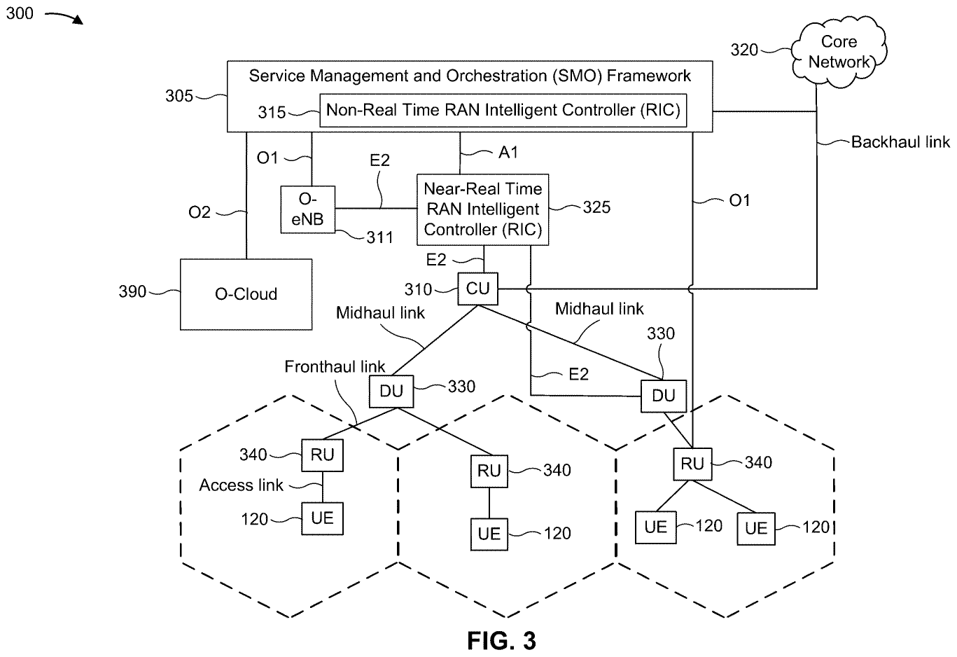

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

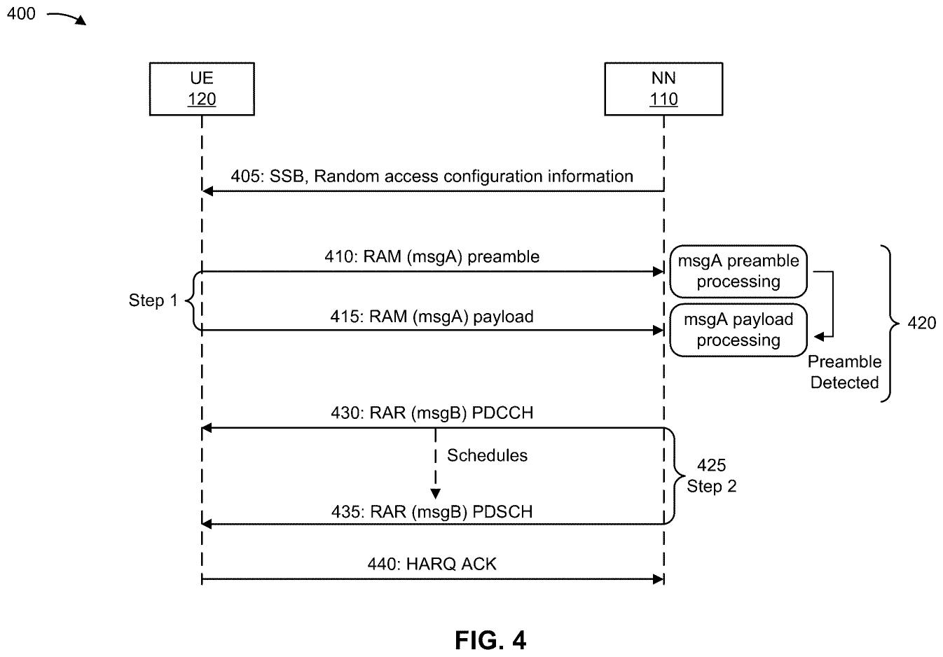

FIG. 4 is a diagram illustrating an example 400 of a two-step random access procedure, in accordance with the present disclosure. As shown in FIG. 4, a network node 110 and a UE 120 may communicate with one another to perform the two-step random access procedure.

As shown by reference number 405, the network node 110 may transmit, and the UE 120 may receive, one or more synchronization signal blocks (SSBs) and random access configuration information. In some examples, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 410, the UE 120 may transmit, and the network node 110 may receive, a RAM preamble. As shown by reference number 415, the UE 120 may transmit, and the network node 110 may receive, a RAM payload. As shown, the UE 120 may transmit the RAM preamble and the RAM payload to the network node 110 as part of an initial (or first) step of the two-step random access procedure. In some examples, the RAM may be referred to as message A, msgA, a first message, or an initial message in a two-step random access procedure. Furthermore, in some examples, the RAM preamble may be referred to as a message A preamble, a msgA preamble, a preamble, or a physical random access channel (PRACH) preamble, and the RAM payload may be referred to as a message A payload, a msgA payload, or a payload. In some examples, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a physical uplink shared channel (PUSCH) transmission).

As shown by reference number 420, the network node 110 may receive the RAM preamble transmitted by the UE 120. If the network node 110 successfully receives and decodes the RAM preamble, the network node 110 may then receive and decode the RAM payload.

As shown by reference number 425, the network node 110 may transmit an RAR (sometimes referred to as an RAR message). As shown, the network node 110 may transmit the RAR message as part of a second step of the two-step random access procedure. In some examples, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 430, as part of the second step of the two-step random access procedure, the network node 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication.

As shown by reference number 435, as part of the second step of the two-step random access procedure, the network node 110 may transmit the PDSCH communication for the RAR, as scheduled by the PDCCH communication. The RAR may be included in a medium access control (MAC) protocol data unit (PDU) of the PDSCH communication. As shown by reference number 440, if the UE 120 successfully receives the RAR, the UE 120 may transmit a hybrid automatic repeat request (HARQ) acknowledgement (ACK).

As indicated above, FIG. 4 is provided as an example. Other examples may differ from what is described with regard to FIG. 4.

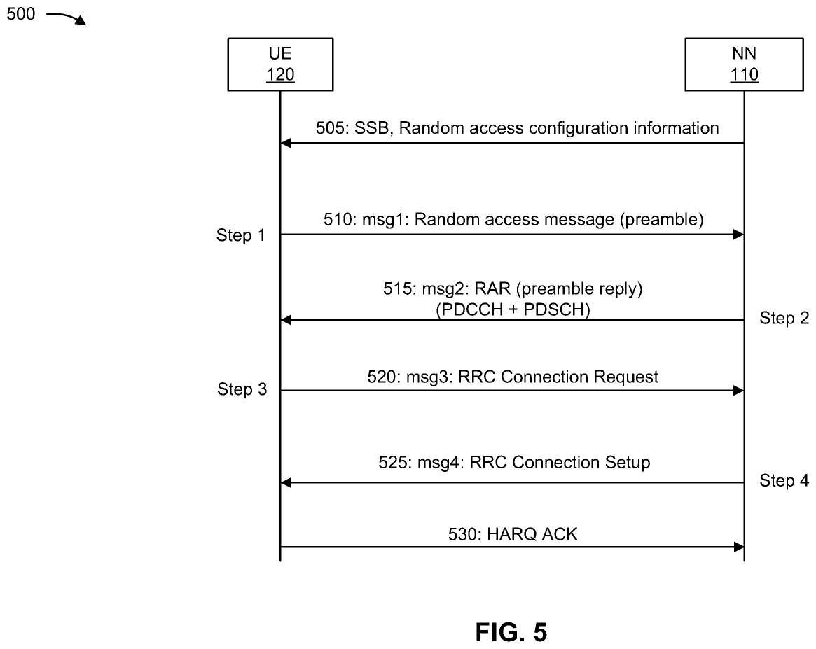

FIG. 5 is a diagram illustrating an example 500 of a four-step random access procedure, in accordance with the present disclosure. As shown in FIG. 5, a network node 110 and a UE 120 may communicate with one another to perform the four-step random access procedure.

As shown by reference number 505, the network node 110 may transmit, and the UE 120 may receive, one or more SSBs and random access configuration information. In some examples, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 510, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the network node 110 may transmit an RAR as a reply to the preamble. The message that includes the RAR may be referred to as message 2, msg2, MSG2, or a second message in a four-step random access procedure. In some examples, the RAR may indicate the detected random access preamble identifier (e.g., received from the UE 120 in msg1). Additionally, or alternatively, the RAR may indicate a resource allocation to be used by the UE 120 to transmit message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 520, the UE 120 may transmit an RRC connection request message. The RRC connection request message may be referred to as message 3, msg3, MSG3, or a third message of a four-step random access procedure. In some examples, the RRC connection request may include a UE identifier, UCI, and/or a PUSCH communication (e.g., an RRC connection request).

As shown by reference number 525, the network node 110 may transmit an RRC connection setup message. The RRC connection setup message may be referred to as message 4, msg4, MSG4, or a fourth message of a four-step random access procedure. In some examples, the RRC connection setup message may include the detected UE identifier, a timing advance value, and/or contention resolution information. As shown by reference number 530, if the UE 120 successfully receives the RRC connection setup message, the UE 120 may transmit a HARQ ACK.

As indicated above, FIG. 5 is provided as an example. Other examples may differ from what is described with regard to FIG. 5.

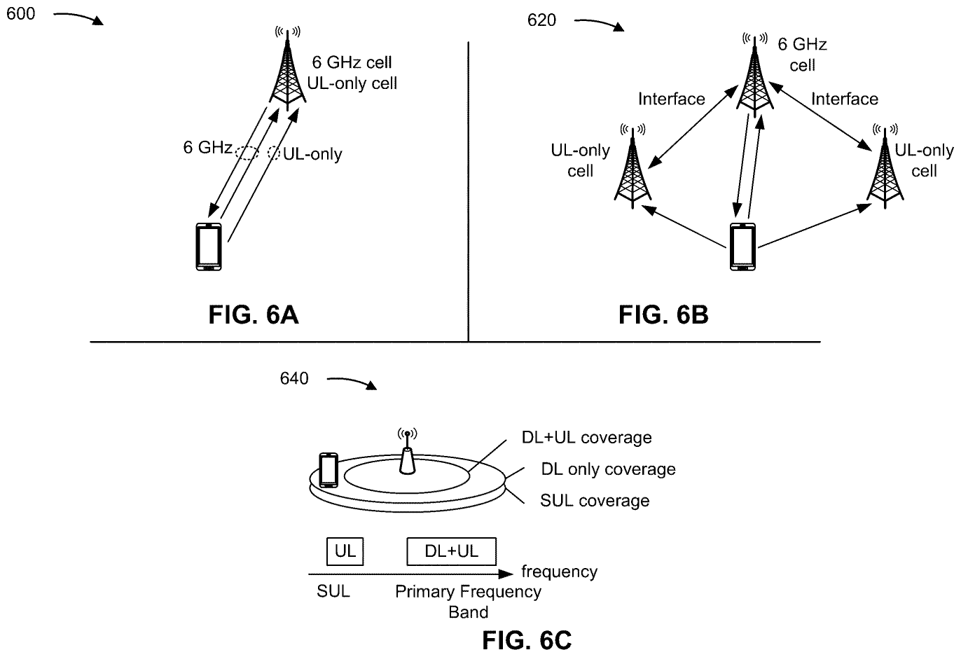

FIGS. 6A-6C are diagrams illustrating examples of uplink-only cells, in accordance with the present disclosure.

As shown in FIG. 6A, and by example 600, a co-located deployment may include a UE 120 communicating with a single network node 110 via a set of carriers of a set of cells. For example, the UE 120 may communicate on an uplink and a downlink of a bidirectional cell (e.g., a primary frequency band, such as a 5G/NR frequency band, an FR2 frequency band, a 6 gigahertz (GHz) frequency band, an FR3 (7 GHz-24 GHZ) frequency band, or another frequency band). Additionally, or alternatively, the UE 120 may communicate on an uplink of a unidirectional (e.g., uplink-only) cell. In contrast, as shown in FIG. 6B, and by example 620, in a non-collocated deployment, which may also be referred to as a separated deployment, the UE 120 may communicate with a first network node 110 via the bidirectional cell and with one or more second network nodes 110 via one or more unidirectional cells. In this case, the network nodes 110 may include backhaul interfaces for, for example, relaying information between the UE 120 and the first network node 110.

As shown in FIG. 6C, and by example 640, unidirectional cells can be deployed in a same area as bidirectional cells. For example, in a collocated deployment, a network node 110 may provide a bidirectional cell at a first, high frequency (e.g., a frequency band greater than or equal to 6 GHZ) and a unidirectional cell at a second, lower frequency (e.g., a frequency band less than 6 GHZ). By selecting a higher frequency band for the bidirectional cell, a higher level of throughput may be achieved, such as for the downlink carrier, than is achieved at lower frequencies. In this case, a coverage area for a downlink carrier of the bidirectional cell may be greater than a coverage area for an uplink carrier of the bidirectional cell. This may be a result of the network node 110 having a greater transmit range than the UE 120, due to UE transmit power limitations. In other words, the network node 110 can transmit a downlink signal farther to the UE 120 than the UE 120 can transmit an uplink signal to the network node 110. Accordingly, the unidirectional cell may be provided in the same area as the bidirectional cell to provide increased uplink coverage. For example, by providing the unidirectional cell at a lower frequency range than the bidirectional cell, the UE 120 may have a greater transmit range on an uplink carrier of the unidirectional cell than a transmit range of the UE 120 on an uplink carrier of the bidirectional cell, as shown. In some examples, a deployment that includes a unidirectional cell paired with a bidirectional cell to increase an uplink transmission coverage range may be referred to as a supplementary uplink (SUL) deployment.

As indicated above, FIGS. 6A-6C are provided as examples. Other examples may differ from what is described with respect to FIGS. 6A-6C.

Supplementary uplink deployments may differ from aggregated uplink deployments by allowing a UE to be scheduled to transmit either on a supplementary uplink (e.g., an uplink carrier of a unidirectional cell) or on an uplink of a carrier being supplemented (e.g., an uplink carrier of a bidirectional cell), which may be referred to as a supplemented uplink carrier. For random access procedures on a cell configured with a supplementary uplink, a network node may explicitly indicate which uplink carrier a UE is to use for uplink communications associated with the random access procedures. If the network node does not indicate an uplink carrier, the UE may select a supplementary uplink carrier based at least in part on determining that a channel metric does not satisfy a threshold for using a supplemented uplink carrier. The threshold for the channel metric may be configured by the network node, such as a first threshold being configured for 2-step RACH procedures and a second threshold being configured for 4-step RACH procedures. In these examples, once a RACH procedure is started on a selected uplink carrier, all uplink transmissions of the RACH procedure remain on the selected uplink carrier. However, when an uplink quality on a higher frequency band carrier is poor, statically remaining on the higher frequency band carrier can result in dropped communications.

Some aspects described herein enable uplink selection and switching in initial access assisted by uplink-only cells. For example, a UE may receive configuration information on a downlink carrier of a bidirectional cell. The configuration information may include a threshold for selecting an uplink carrier or an indication of a carrier switch between a first uplink carrier and a second uplink carrier, among other examples. Based at least in part on the configuration information, the UE and a network node may exchange one or more signaling messages. In this case, the UE may transmit to the network node on a first uplink carrier associated with a bidirectional cell or a second uplink carrier associated with a unidirectional cell. In some aspects, the UE may switch between transmitting on the first uplink carrier and transmitting on the second uplink carrier based at least in part on one or more parameters, as described below. Based at least in part on the UE and the network node communicating on the first uplink carrier or the second uplink carrier, the UE and the network node may complete a communication procedure, such as a RACH procedure. In this way, the UE uses a dynamically configured uplink carrier for transmission, thereby reducing a likelihood of failing to complete a communication procedure relative to statically selecting an uplink carrier.

FIGS. 7A-7F are diagrams illustrating an example 700 associated with uplink selection and switching in initial access, in accordance with the present disclosure. As shown in FIG. 7A, example 700 includes communication between a network node 110 and a UE 120.

As further shown in FIG. 7A, and by reference number 710, the UE 120 may receive one or more signaling messages conveying configuration information. For example, the UE 120 may receive one or more signaling messages, from the network node 110 on a downlink carrier of a bidirectional cell, indicating one or more configuration parameters associated with using an uplink carrier of the bidirectional cell and/or an uplink carrier of a unidirectional cell.

In some aspects, the UE 120 may receive configuration information identifying a set of synchronization signal block (SSB) resources. The UE 120 may use the configuration information to receive SSB communications that include information identifying sets of random access channel occasions (ROs). For example, the UE 120 may receive information identifying sets of ROs associated with SSBs, such as a first RO set for the uplink carrier of the bidirectional cell, which may also be referred to as a “supplemented uplink carrier,” a second RO set associated with the uplink carrier of the unidirectional cell, which may also be referred to as a “supplementary uplink carrier,” and/or a third RO set for both the supplemented uplink carrier and the supplementary uplink carrier. In this case, the UE 120 may determine an RO set to use based at least in part on receiving the SSBs.

The third RO set may include RO pairs (sometimes referred to as “RO pair sets”), with each RO pair including a first RO for the supplemented uplink carrier and a second RO for the supplementary uplink carrier (with the first RO and the second RO being multiplexed using time division multiplexing (TDM) or frequency division multiplexing (FDM)). In some aspects, each RO set identified for the UE 120 may be disjoint. In other words, resources of the first RO set, the second RO set, and/or the third RO set may be non-overlapping with each other, to enable contention-based random access (CBRA) procedures to be performed without overlap between the RO sets.

In some aspects, one or more SSB beams may be associated with a common RO. For example, based at least in part on a beam of the supplementary uplink carrier being wider than a beam of the supplemented uplink carrier, a plurality of SSB beams may share a single RO in the supplementary uplink carrier. In this case, a first SSB beam (e.g., that includes a beam in a supplementary uplink carrier) may be associated with a plurality of RO sets (e.g., the first RO set, the second RO set, and the third RO set), but a second SSB beam may be associated with only a single RO set (e.g., as a result of a lack of a beam in a supplementary uplink carrier). In some aspects, the UE 120 may receive an SSB beam and select an associated RO based at least in part on the configuration information. For example, the UE 120 may select an RO in the first RO set to transmit a RACH message (e.g., RACH msg1 or a RACH msgA) on the supplemented uplink carrier, in the second RO set to transmit a RACH message on the supplementary uplink carrier, or in the third RO set to transmit a first instance of a RACH message on the supplemented uplink carrier and a second instance of the RACH message on the supplementary uplink carrier (e.g., using repetition to increase reliability). In this case, as described below, the UE 120 may transmit on an uplink carrier in accordance with the configuration information.

As further shown in FIG. 7A, and by reference number 720, the UE 120 may transmit one or more communications on an uplink carrier of a bidirectional cell or an uplink carrier of a unidirectional cell. For example, based at least in part on the configuration information, the UE 120 may transmit, to the network node 110, on a supplementary uplink carrier or a supplemented uplink carrier.

In some aspects, the UE 120 may transmit a RACH message on an uplink carrier using an RO associated with a received SSB beam and selected based at least in part on the configuration information. For example, based at least in part on receiving SSBs, the UE 120 may select a beam and an associated RO to transmit a first RACH message, such as RACH msg1, as described above. In this case, the UE 120 may select the beam based at least in part on measured channel conditions, such as selecting the beam and the associated RO for the supplemented uplink carrier, the supplementary uplink carrier, or both the supplemented uplink carrier and the supplementary uplink carrier (e.g., for repetition of the RACH msg1). In this case, for RACH msg1 retransmission (e.g., when the UE 120 fails to detect a RACH msg2 from the network node 110 as a response to transmitting a RACH msg1 transmission), the UE 120 may choose an RO or an RO pair from a different RO set than an initial selection. In other words, when the UE 120 selects an RO from an RO set for the supplemented uplink carrier and fails to detect a RACH msg2 response, the UE 120 may select another RO from another RO set (e.g., for the supplementary uplink carrier or for both the supplementary uplink carrier and the supplemented uplink carrier) for a retransmission of the RACH msg1.

In some aspects, the UE 120 may receive a second RACH message (e.g., a response message) based at least in part on transmitting a first RACH message in accordance with the configuration information. For example, the UE 120 may receive a random access response (RAR) message, such as RACH msg2 or RACH msgB, based at least in part on transmitting a RACH message (e.g., RACH msg1). In some aspects, the network node 110 may transmit the RAR message based at least in part on the UE 120 transmitting a plurality of instances of the RACH msg1 (e.g., in an RO pair of an RO set for both the supplemented uplink carrier and the supplementary uplink carrier). In this case, the network node 110 may transmit the RAR message based at least in part on receiving at least one of the RACH msg1 instances.

In some aspects, the network node 110 may select a random access (RA) radio network temporary identifier (RNTI) (RA-RNTI) for the RAR message. For example, the network node 110 may select the RA-RNTI based at least in part on a received RACH msg1 instance. The UE 120 may monitor for a physical downlink control channel (PDCCH) downlink control information (DCI) with the RA-RNTI and convey the RACH msg2 in a configured RAR window. In some aspects, the RA-RNTI may be based at least in part on a supplemented cell RO of an RO pair. For example, when the network node 110 decodes a RACH msg1 in a supplementary uplink carrier and fails to decode the RACH msg1 in a supplemented uplink carrier, the network node 110 may use an RO of the supplemented uplink carrier RACH msg1 within the RO pair for determining the RA-RNTI, which reduces blind decoding complexity at the UE 120 since the UE 120 only has to monitor the RA-RNTI corresponding to the supplemented cell RO. Additionally, or alternatively, the RA-RNTI may be based at least in part on a supplementary cell RO of an RO pair. For example, when the network node 110 decodes a RACH msg1 in a supplemented uplink carrier and fails to decode the RACH msg1 in a supplementary uplink carrier, the network node 110 may use an RO of the supplementary uplink carrier RACH msg1 within the RO pair for determining the RA-RNTI, which reduces blind decoding complexity at the UE 120 since the UE 120 only has to monitor the RA-RNTI corresponding to the supplementary cell RO.

Additionally, or alternatively, the RA-RNTI may be based at least in part on a decoded RACH msg1. In this case, the network node 110 uses an RO of whichever RACH msg1 was successfully decoded to determine the RA-RNTI, and the UE 120 may monitor for RA-RNTIs of both an RO for the supplementary uplink carrier and an RO for the supplemented uplink carrier (e.g., as the UE 120 does not have information identifying which RACH msg1 was successfully decoded), which reduces complexity at the network node 110. In some aspects, the network node 110 may transmit an indicator, in the configuration information (e.g., in a system information block (SIB), a master information block (MIB), or an SSB), of a rule that the network node 110 will use for selecting an RA-RNTI, as described above. For example, the rule may indicate whether the RA-RNTI is based at least in part on the supplemented cell RO of the RO pair, the supplementary cell RO of the RO pair, or whichever RACH msg1 was successfully decoded. Additional examples of the rule are provided below.

In some aspects, the RA-RNTI may be based at least in part on an RO that is included in only a single RO pair. For example, when a first RO of an RO pair is included in a plurality of RO pairs, the network node 110 may determine the RA-RNTI based at least in part on a second RO of the RO pair that is not included in any other RO pairs (other than an RO pair that the UE 120 used to convey the RACH msg1). In this case, the network node 110 may indicate a one-to-multiple RO mapping in a RACH configuration message. In some aspects, the RA-RNTI for the RAR message may be based at least in part on a plurality of RA-RNTIs. For example, the network node 110 may determine a first RA-RNTI based at least in part on a first RO for the supplemented uplink carrier and a second RA-RNTI based at least in part on a second RO for the supplementary uplink carrier. In this case, the network node 110 may determine the RA-RNTI for the DCI conveying the RACH msg2 using a mathematical operation such as, for example, a sum of the first RA-RNTI and the second RA-RNTI. As above, the network node 110 may transmit an indicator, in the configuration information (e.g., in a SIB, a MIB, or an SSB), of a rule that the network node 110 will use for selecting an RA-RNTI.

In some aspects, the UE 120 may monitor for the RAR message (e.g., the RACH msg2) in an RAR window. For example, the UE 120 may determine an RAR window based at least in part on a last symbol in which the UE 120 transmits a RACH msg1. In this case, when the UE 120 transmits a plurality of instances of the RACH msg1, the UE 120 may start the RAR window based at least in part on an occurrence of a last symbol of the plurality of instances of the RACH msg1.

In some aspects, the UE 120 may receive configuration information in connection with receiving the RAR message. For example, the UE 120 may receive, in a payload of a RACH msg2 (e.g., an uplink grant), information indicating a carrier on which the UE 120 is to transmit another RACH message (e.g., RACH msg3).

Additionally, or alternatively, the UE 120 may receive an indication of which carrier to use for transmitting the RACH msg3 in an RA-RNTI. For example, the network node 110 may select an RA-RNTI that is based at least in part on an RO associated with the supplementary uplink carrier to indicate that the UE 120 is to use the supplementary uplink carrier for transmitting the RACH msg3, or vice versa. As shown in FIG. 7B, when the UE 120 transmits RACH msg1 on a 6 GHz cell (e.g., a supplemented uplink carrier) and on an uplink-only cell (e.g., a supplementary uplink carrier), the UE 120 receives a single RACH msg2 response scrambled by an RA-RNTI. In this case, the UE 120 may determine whether to transmit the RACH msg3 on the 6 GHZ cell or the uplink-only cell based at least in part on a payload of the RACH msg2 or a value of the RA-RNTI.

Additionally, or alternatively, the carrier for transmitting the RACH msg3 may be based at least in part on a network measurement, such as based at least in part on a reference signal received power (RSRP) or a reference signal received quality (RSRQ) of the RACH msg1 measured at the network node 110. Additionally, or alternatively, the carrier may be based at least in part on respective cell loads or bandwidths of the uplink carriers, or based at least on part on a load of the uplink-only cell (due to the lower frequency band and limited bandwidth of the uplink-only cell). In some aspects, the UE 120 may determine which carrier to use for transmitting the RACH msg3 based at least in part on a power criterion. For example, the UE 120 may receive an indication of a target power P_{RACH,target} for uplink power control within an RO pair set and may use the target power for ROs within an RO pair. In a first case, when a RACH power, P_{RACH}, is less than or equal to an open loop power control, P_{CMAX}, for both uplink carriers of an RO pair, P_{RACH,target} may be satisfied for both uplink carriers with a similar RSRP or RSRQ. In contrast, when P_{RACH}=P_{CMAX} for a single uplink carrier and P_{RACH,target} is not satisfied, there may be different RSRPs or RSRQs for the two uplink carriers.

In some aspects, the network node 110 may schedule a retransmission of the RACH msg3 based at least in part on failing to receive the RACH msg3 from the UE 120. For example, when an initial transmission of the RACH msg3 is in the supplemented uplink carrier, the network node 110 may trigger retransmission of the RACH msg3 in the supplementary uplink carrier, which may have less pathloss and/or a higher link budget, thereby resulting in a greater likelihood of successful communication. In some aspects, the network node 110 may indicate an uplink carrier for the UE 120 to use for retransmission of the RACH msg3 using DCI. For example, the network node 110 may transmit a first format of DCI (e.g., DCI 0, such as DCI 0_0 or DCI 0_x) scrambled by a previously configured temporary cell-specific RNTI (TC-RNTI) to indicate retransmission of the RACH msg3. In this case, the first format of DCI may include a field or other indicator associated with indicating that the UE 120 is to reuse a previously configured TC-RNTI (e.g., in a RACH msg2) for RACH msg3 retransmission. Additionally, or alternatively, the first format of DCI may include a field or other indicator associated with indicating whether to retransmit the RACH msg3 in the supplemented uplink carrier or the supplemental uplink carrier. As an example, as shown in FIG. 7C, in a first example 750, the UE 120 may receive a RACH msg2 and attempt to transmit a RACH msg3 (scrambled with a TC-RNTI) in a 6 GHz cell. The UE 120 may receive DCI 0 with an uplink grant for RACH msg3 retransmission. The DCI 0 is scrambled by the TC-RNTI and indicates that RACH msg3 retransmission is to occur in the supplemented uplink carrier (of the 6 GHz cell) or the supplementary uplink carrier (of an uplink-only cell).

Additionally, or alternatively, the network node 110 may transmit a second format of DCI (e.g., DCI 1, such as DCI 1_0 or DCI 1_x) scrambled by a previously configured TC-RNTI (e.g., in a RACH msg2) and an associated PDSCH. In this case, the PDSCH may include a field or other indicator indicating that the UE 120 is to use a new TC-RNTI (e.g., different from that in the RACH msg2) for RACH msg3 retransmission. The PDSCH may include an uplink grant for the RACH msg3 retransmission, an identifier of a new TC-RNTI, an indication to reuse a previously indicated TC-RNTI, or an indication of an uplink carrier to use for the RACH msg3 retransmission, among other examples. As an example, as shown in FIG. 7C, in a second example 751, the UE 120 may receive a RACH msg2 and attempt to transmit a RACH msg3 scrambled by a TC-RNTI. The UE 120 may receive DCI 1 and an associated PDSCH. In this case, the PDSCH includes an indication of whether to retransmit the RACH msg3 in the supplemented uplink carrier or the supplementary uplink carrier.

In some aspects, the network node 110 may indicate that the UE 120 is to retransmit RACH msg3 in the supplementary uplink carrier after successful transmission of the RACH msg1 in the supplemented uplink carrier. The RACH msg1 is a sequence and detected by coherent detection in the time domain, which may be detectable at a lower signal-to-interference-and-noise ratio (SINR) at a receiver side than a RACH msg3, which is a PUSCH transmission. Accordingly, the network node 110 may successfully receive RACH msg1 under channel conditions where the network node 110 is unlikely to successfully receive RACH msg3. Accordingly, the network node 110 may transmit a DCI 0 scrambled by a previously configured TC-RNTI in RACH msg2, which may indicate that the UE 120 is to retransmit RACH msg3 using the supplementary uplink carrier. Similarly, the network node 110 may transmit a DCI 1 scrambled with a previously configured TC-RNTI in a RACH msg2 and a PDSCH associated with the DCI 1 to indicate that the UE 120 is to retransmit RACH msg3 using the supplementary uplink carrier.

In some aspects, the UE 120 may determine a transmit power for retransmitting the RACH msg3. For example, when the RACH msg3 retransmission is a result of a UE collision (e.g., the UE 120 and another UE choosing the same RO or RO pair for RACH msg1 transmission), the UE 120 may have the RACH msg3 retransmission rescheduled to a different uplink cell than an initial transmission. In other words, the UE 120 may switch from a first instance of transmitting the RACH msg3 on a first uplink carrier to retransmitting the RACH msg3 on a second uplink carrier. In this case, the UE 120 may determine the transmit power for the retransmission of the RACH msg3 on the second uplink carrier based at least in part on the transmit power of the initial transmission of the RACH msg3 on the first uplink carrier. In other words, the UE 120 may use an accumulated transmit power control (TPC) command for retransmitting the RACH msg3. Additionally, or alternatively, the UE 120 may reset a TPC value and may use a retransmission TPC table (e.g., which may have a larger value range and step size compared with an initial transmission TPC table) for retransmission of the RACH msg3 on the second uplink carrier. Based at least in part on transmitting (or retransmitting) the RACH msg3, the UE 120 may monitor to receive a RACH msg4 as a response.

In some aspects, the UE 120 may determine to re-initiate a RACH procedure based at least in part on expiration of a timer. For example, when a contention resolution timer expires, the UE 120 may determine that a RACH msg4 transmission has failed and may select an RO or RO pair for a RACH msg1 transmission to re-initiate a RACH procedure.

FIG. 7D shows an example of a first set of signals 760 that may occur in connection with the transmitting and/or receiving described with respect to reference number 720. For example, based at least in part on receiving configuration information configuring a supplemented uplink carrier and a supplementary uplink carrier, the UE 120 may receive an SSB transmission on the bidirectional cell, at 761, and perform an SSB beam management and selection procedure at 762. The UE 120 may, on the supplementary uplink carrier and the supplemented uplink carrier, transmit a RACH msg1 in ROs of an RO pair associated with a selected beam, at 763a and 763b. When the RACH msg1 is received on the supplementary uplink carrier, the network node 110 may pass the RACH msg1 between the unidirectional cell and the bidirectional cell in a measurement report, at 764. The UE 120 may receive a RACH msg2, at 765. The UE 120 may transmit an initial instance of a RACH msg3 on the supplementary uplink carrier or the supplemented uplink carrier, at 766a and 766b. When the RACH msg3 is not successfully received, the network node 110 may transmit DCI 0 with an uplink grant for RACH msg3 retransmission, at 767, or DCI 1 with a PDSCH conveying a message triggering RACH msg3 retransmission, at 768. The UE 120 may retransmit the RACH msg3 on the supplementary uplink carrier or the supplemented uplink carrier, at 769a and 769b. When the RACH msg3 retransmission is received on the supplementary uplink carrier, the network node 110 may pass the RACH msg3 from the unidirectional cell to the bidirectional cell in a measurement report or a forwarding message, at 770. The UE 120 may receive a RACH msg4 from the bidirectional cell, at 771.

FIG. 7E shows an example of a second set of signals 775 that may occur in connection with the transmitting and/or receiving described with respect to reference number 720. For example, based at least in part on receiving configuration information configuring a supplemented uplink carrier and a supplementary uplink carrier, the UE 120 may receive an SSB transmission on the bidirectional cell, at 775, and perform an SSB beam management and selection procedure at 776. The UE 120 may transmit, on the supplemented uplink carrier, a RACH msg1 in ROs associated with a selected beam, at 777. The UE 120 may receive a RACH msg2, at 778. The UE 120 may transmit an initial instance of a RACH msg3 on the supplemented uplink carrier using a configuration based at least in part on the RACH msg2, at 779. When the RACH msg3 is not successfully received, the network node 110 may transmit DCI 0 with an uplink grant for RACH msg3 retransmission, at 780, or DCI 1 with a PDSCH conveying a message triggering RACH msg3 retransmission, at 781. The UE 120 may retransmit the RACH msg3 on the supplementary uplink carrier, at 782. The network node 110 may pass the RACH msg3 from the unidirectional cell to the bidirectional cell in a measurement report or a forwarding message, at 783. The UE 120 may receive a RACH msg4 from the bidirectional cell, at 784.

FIG. 7F shows an example of a third set of signals 790 that may occur in connection with the transmitting and/or receiving described with respect to reference number 720. For example, based at least in part on receiving configuration information configuring a supplemented uplink carrier and a supplementary uplink carrier, the UE 120 may receive an SSB transmission on the bidirectional cell, at 791, and perform an SSB beam management and selection procedure at 792. The UE 120 may transmit, on the supplemented uplink carrier, a RACH msgA in an RO associated with a selected beam and an associated RO, at 793. In this case, the network node 110 may receive the RACH msgA preamble successfully on the supplemented uplink carrier, but may not receive the RACH msgA payload data successfully. Accordingly, the network node 110 may trigger fallback RAR, in which the network node 110 and the UE 120 switch from two-step RACH to four-step RACH. Here, the UE 120 may receive a RACH msg2, at 794, triggering fallback RAR and indicating that the UE 120 is to transmit a RACH msg3 using the supplementary uplink carrier. The UE 120 may transmit an initial instance of a RACH msg3 on the supplementary uplink carrier, at 795. The network node 110 may pass the RACH msg3 from the unidirectional cell to the bidirectional cell in a measurement report or a forwarding message, at 796. The UE 120 may receive a RACH msg 4 from the bidirectional cell, at 797.

As indicated above, FIGS. 7A-7F are provided as an example. Other examples may differ from what is described with respect to FIGS. 7A-7F.

FIG. 8 is a diagram illustrating an example process 800 performed, for example, by a UE, in accordance with the present disclosure. Example process 800 is an example where the UE (e.g., UE 120) performs operations associated with uplink selection and switching in initial access.

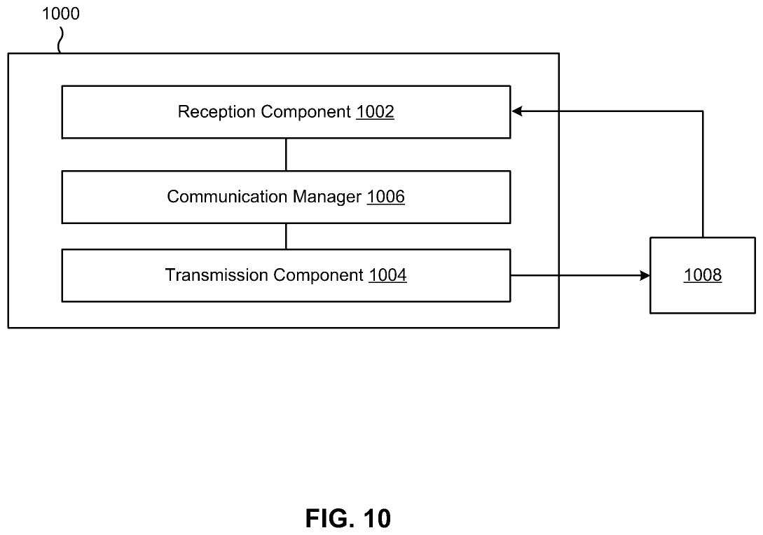

As shown in FIG. 8, in some aspects, process 800 may include receiving, on a downlink carrier of a bidirectional cell having the downlink carrier and a first uplink carrier, configuration information (block 810). For example, the UE (e.g., using reception component 1002 and/or communication manager 1006, depicted in FIG. 10) may receive, on a downlink carrier of a bidirectional cell having the downlink carrier and a first uplink carrier, configuration information, as described above.

As further shown in FIG. 8, in some aspects, process 800 may include transmitting, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range (block 820). For example, the UE (e.g., using transmission component 1004 and/or communication manager 1006, depicted in FIG. 10) may transmit, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range, as described above.

Process 800 may include additional aspects, such as any single aspect or any combination of aspects described below and/or in connection with one or more other processes described elsewhere herein.

In a first aspect, process 800 includes receiving an SSB communication in the bidirectional cell, wherein each SSB beam, of a group of SSB beams for the SSB communication, is associated with one or more sets of ROs.

In a second aspect, alone or in combination with the first aspect, the one or more sets of ROs includes at least one of a first set of ROs associated with the bidirectional cell, a second set of ROs associated with the unidirectional cell, or a third set of ROs associated with both the bidirectional cell and the unidirectional cell.

In a third aspect, alone or in combination with one or more of the first and second aspects, process 800 includes selecting an SSB beam, from the group of SSB beams, as a selected SSB beam, and determining a set of ROs, of the one or more sets of ROs, as a determined set of ROs based at least in part on the selected SSB beam, and transmitting the first RACH message comprises transmitting the first RACH message in the determined set of ROs.

In a fourth aspect, alone or in combination with one or more of the first through third aspects, the first RACH message is a RACH msg1 or a RACH msgA.

In a fifth aspect, alone or in combination with one or more of the first through fourth aspects, determining the set of ROs comprises determining a single RO to transmit the first RACH message in a single cell of the bidirectional cell or the unidirectional cell, or determining an RO pair to transmit the first RACH message, concurrently, on the bidirectional cell and the unidirectional cell.

In a sixth aspect, alone or in combination with one or more of the first through fifth aspects, process 800 includes determining another set of ROs, of the one or more sets of ROs, as a new determined set of ROs, and retransmitting the first RACH message in the other set of ROs, wherein the determined set of ROs is associated with a first RO set, of the one or more sets of ROs, and the new determined set of ROs is associated with a second RO set, of the one or more sets of ROs, the first RO set being different than the second RO set.

In a seventh aspect, alone or in combination with one or more of the first through sixth aspects, process 800 includes receiving, as a response to transmitting the first RACH message, a second RACH message.

In an eighth aspect, alone or in combination with one or more of the first through seventh aspects, process 800 includes transmitting, based at least in part on receiving the second RACH message, a third RACH message, wherein a configuration of the third RACH message is based at least in part on a configuration of the second RACH message.

In a ninth aspect, alone or in combination with one or more of the first through eighth aspects, a cell, of the unidirectional cell and the bidirectional cell, for transmitting the third RACH message is based at least in part on at least one of an indicator in a payload of the second RACH message, an RA-RNTI of the second RACH message, or a measurement of the first RACH message.

In a tenth aspect, alone or in combination with one or more of the first through ninth aspects, the second RACH message is associated with an RA-RNTI that is based at least in part on the first RACH message.

In an eleventh aspect, alone or in combination with one or more of the first through tenth aspects, the RA-RNTI is based at least in part on a mapping rule, the mapping rule including that the RA-RNTI is based at least in part on one of a first RO, of an RO pair, associated with the bidirectional cell, a second RO, of the RO pair, associated with the unidirectional cell, the first RO or the second RO based at least in part on whether the RACH message is successfully decoded in the first RO or the second RO, an RO, of the first RO or the second RO, that is included in the RO pair and not another RO pair, or a mathematical operation applied to respective RA-RNTIs of the first RO and the second RO.

In a twelfth aspect, alone or in combination with one or more of the first through eleventh aspects, receiving the configuration information comprises receiving an indication of the mapping rule in at least one of a system information block, a master information block, or a synchronization signal block.

In a thirteenth aspect, alone or in combination with one or more of the first through twelfth aspects, receiving the second RACH message comprises receiving the second RACH message in an RAR window, wherein the RAR window is based at least in part on a last symbol of the first RACH message as transmitted on the bidirectional cell and as transmitted on the unidirectional cell.

In a fourteenth aspect, alone or in combination with one or more of the first through thirteenth aspects, process 800 includes transmitting a third RACH message, receiving, based at least in part on transmitting the third RACH message, DCI associated with triggering a retransmission of the third RACH message, wherein the DCI is scrambled using a TC-RNTI associated with a second RACH message.

In a fifteenth aspect, alone or in combination with one or more of the first through fourteenth aspects, the DCI is a first format of DCI including an uplink grant, wherein the uplink grant is for the retransmission of the third RACH message.

In a sixteenth aspect, alone or in combination with one or more of the first through fifteenth aspects, the DCI is a second format of DCI scheduling a PDSCHI, wherein the PDSCH includes an indication of the retransmission of the third RACH message.

In a seventeenth aspect, alone or in combination with one or more of the first through sixteenth aspects, process 800 includes receiving an indication of one or more parameters to use for the retransmission of the RACH message, the one or more parameters including at least one of whether to reuse the TC-RNTI, an indication of a new TC-RNTI, an indication of a cell, of the unidirectional cell or the bidirectional cell, to use for the retransmission of the third RACH message, or an uplink grant for the retransmission of the third RACH message.

In an eighteenth aspect, alone or in combination with one or more of the first through seventeenth aspects, further comprising retransmitting the third RACH message based at least in part on receiving the DCI.

In a nineteenth aspect, alone or in combination with one or more of the first through eighteenth aspects, a power control parameter for the retransmission of the third RACH message is based at least in part on at least one of a transmit power of an initial transmission of the third RACH message, a reset transmit power control counter, or a retransmission transmit power control table entry.

In a twentieth aspect, alone or in combination with one or more of the first through nineteenth aspects, the first RACH message and an initial transmission of the third RACH message occurred in the bidirectional cell, and retransmitting the third RACH message further comprises retransmitting the third RACH message in the unidirectional cell.

In a twenty-first aspect, alone or in combination with one or more of the first through twentieth aspects, process 800 includes receiving, based at least in part on transmitting a RACH msgA as the first RACH message in the bidirectional cell, an indicator to switch from a two-step RACH procedure to a four-step RACH procedure, and transmitting, based at least in part on receiving the indicator, a RACH msg3 as a third RACH message in the unidirectional cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with uplink selection and switching in initial access.

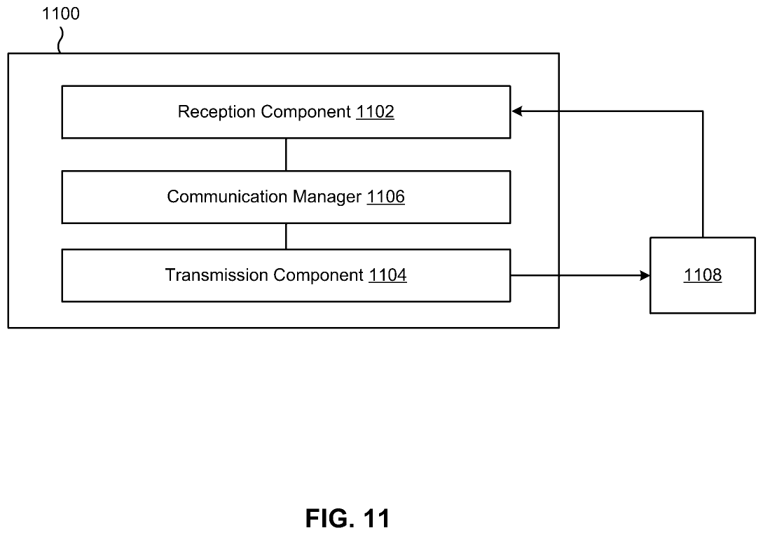

As shown in FIG. 9, in some aspects, process 900 may include transmitting, on a downlink carrier of a bidirectional cell having the downlink carrier and a first uplink carrier, configuration information (block 910). For example, the network node (e.g., using transmission component 1104 and/or communication manager 1106, depicted in FIG. 11) may transmit, on a downlink carrier of a bidirectional cell having the downlink carrier and a first uplink carrier, configuration information, as described above.

As further shown in FIG. 9, in some aspects, process 900 may include receiving, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range (block 920). For example, the network node (e.g., using reception component 1102 and/or communication manager 1106, depicted in FIG. 11) may receive, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range, as described above.

Process 900 may include additional aspects, such as any single aspect or any combination of aspects described below and/or in connection with one or more other processes described elsewhere herein.

In a first aspect, process 900 includes transmitting an SSB communication in the bidirectional cell, wherein each SSB beam, of a group of SSB beams for the SSB communication, is associated with one or more sets of ROs.

In a second aspect, alone or in combination with the first aspect, the one or more sets of ROs includes at least one of a first set of ROs associated with the bidirectional cell, a second set of ROs associated with the unidirectional cell, or a third set of ROs associated with both the bidirectional cell and the unidirectional cell.

In a third aspect, alone or in combination with one or more of the first and second aspects, receiving the first RACH message comprises receiving the first RACH message in a determined set of ROs, the determined set of ROs being based at least in part on a selected SSB beam from the group of SSB beams.

In a fourth aspect, alone or in combination with one or more of the first through third aspects, the first RACH message is a RACH msg1 or a RACH msgA.

In a fifth aspect, alone or in combination with one or more of the first through fourth aspects, determining set of ROs comprises a single RO to convey the first RACH message in a single cell of the bidirectional cell or the unidirectional cell, or an RO pair to convey the first RACH message, concurrently, on the bidirectional cell and the unidirectional cell.

In a sixth aspect, alone or in combination with one or more of the first through fifth aspects, process 900 includes receiving a retransmission of the first RACH message in a new determined set of ROs, wherein the determined set of ROs is associated with a first RO set, of the one or more sets of ROs, and the new determined set of ROs is associated with a second RO set, of the one or more sets of ROs, the first RO set being different than the second RO set.

In a seventh aspect, alone or in combination with one or more of the first through sixth aspects, process 900 includes transmitting, as a response to receiving the first RACH message, a second RACH message.

In an eighth aspect, alone or in combination with one or more of the first through seventh aspects, process 900 includes receiving, based at least in part on transmitting the second RACH message, a third RACH message, wherein a configuration of the third RACH message is based at least in part on a configuration of the second RACH message.

In a ninth aspect, alone or in combination with one or more of the first through eighth aspects, a cell, of the unidirectional cell and the bidirectional cell, for receiving the third RACH message is based at least in part on at least one of an indicator in a payload of the second RACH message, an RA-RNTI of the second RACH message, or a measurement of the first RACH message.

In a tenth aspect, alone or in combination with one or more of the first through ninth aspects, the second RACH message is associated with an RA-RNTI that is based at least in part on the first RACH message.

In an eleventh aspect, alone or in combination with one or more of the first through tenth aspects, the RA-RNTI is based at least in part on a mapping rule, the mapping rule including that the RA-RNTI is based at least in part on one of a first RO, of an RO pair, associated with the bidirectional cell, a second RO, of the RO pair, associated with the unidirectional cell, the first RO or the second RO based at least in part on whether the RACH message is successfully decoded in the first RO or the second RO, an RO, of the first RO or the second RO, that is included in the RO pair and not another RO pair, or a mathematical operation applied to respective RA-RNTIs of the first RO and the second RO.

In a twelfth aspect, alone or in combination with one or more of the first through eleventh aspects, transmitting the configuration information comprises transmitting an indication of the mapping rule in at least one of a system information block, a master information block, or a synchronization signal block.

In a thirteenth aspect, alone or in combination with one or more of the first through twelfth aspects, transmitting the second RACH message comprises transmitting the second RACH message in an RAR window, wherein the RAR window is based at least in part on a last symbol of the first RACH message as transmitted on the bidirectional cell and as transmitted on the unidirectional cell.

In a fourteenth aspect, alone or in combination with one or more of the first through thirteenth aspects, process 900 includes receiving a third RACH message, and transmitting, based at least in part on receiving the third RACH message, DCI associated with triggering a retransmission of the third RACH message, wherein the DCI is scrambled using a TC-RNTI associated with a second RACH message.

In a fifteenth aspect, alone or in combination with one or more of the first through fourteenth aspects, the DCI is a first format of DCI including an uplink grant, wherein the uplink grant is for the retransmission of the third RACH message.

In a sixteenth aspect, alone or in combination with one or more of the first through fifteenth aspects, the DCI is a second format of DCI scheduling a PDSCH, wherein the PDSCH includes an indication of the retransmission of the third RACH message.

In a seventeenth aspect, alone or in combination with one or more of the first through sixteenth aspects, process 900 includes transmitting an indication of one or more parameters to use for the retransmission of the RACH message, the one or more parameters including at least one of whether to reuse the TC-RNTI, an indication of a new TC-RNTI, an indication of a cell, of the unidirectional cell or the bidirectional cell, to use for the retransmission of the third RACH message, or an uplink grant for the retransmission of the third RACH message.

In an eighteenth aspect, alone or in combination with one or more of the first through seventeenth aspects, further comprising receiving a retransmission of the third RACH message based at least in part on transmitting the DCI.

In a nineteenth aspect, alone or in combination with one or more of the first through eighteenth aspects, a power control parameter for the retransmission of the third RACH message is based at least in part on at least one of a transmit power of an initial transmission of the third RACH message, a reset transmit power control counter, or a retransmission transmit power control table entry.

In a twentieth aspect, alone or in combination with one or more of the first through nineteenth aspects, the first RACH message and an initial transmission of the third RACH message occurred in the bidirectional cell, and receiving the retransmission of the third RACH message further comprises receiving the retransmission of the third RACH message in the unidirectional cell.

In a twenty-first aspect, alone or in combination with one or more of the first through twentieth aspects, process 900 includes transmitting, based at least in part on receiving a RACH msgA as the first RACH message in the bidirectional cell, an indicator to switch from a two-step RACH procedure to a four-step RACH procedure, and receiving, based at least in part on transmitting the indicator, a RACH msg3 as a third RACH message in the unidirectional cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 7A-7F. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, on a downlink carrier of a bidirectional cell having the downlink carrier and a first uplink carrier, configuration information. The transmission component 1004 may transmit, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

The reception component 1002 may receive a synchronization signal block (SSB) communication in the bidirectional cell, wherein each SSB beam, of a group of SSB beams for the SSB communication, is associated with one or more sets of ROs.

The communication manager 1006 may select an SSB beam, from the group of SSB beams, as a selected SSB beam. The communication manager 1006 may determine a set of ROs, of the one or more sets of ROs, as a determined set of ROs based at least in part on the selected SSB beam. The communication manager 1006 may determine another set of ROs, of the one or more sets of ROs, as a new determined set of ROs.

The transmission component 1004 may retransmit the first RACH message in the other set of ROs, wherein the determined set of ROs is associated with a first RO set, of the one or more sets of ROs, and the new determined set of ROs is associated with a second RO set, of the one or more sets of ROs, the first RO set being different than the second RO set. The reception component 1002 may receive, as a response to transmitting the first RACH message, a second RACH message. The transmission component 1004 may transmit, based at least in part on receiving the second RACH message, a third RACH message, wherein a configuration of the third RACH message is based at least in part on a configuration of the second RACH message. The transmission component 1004 may transmit a third RACH message.

The reception component 1002 may receive, based at least in part on transmitting the third RACH message, DCI associated with triggering a retransmission of the third RACH message, wherein the DCI is scrambled using a TC-RNTI associated with a second RACH message. The reception component 1002 may receive an indication of one or more parameters to use for the retransmission of the RACH message, the one or more parameters including at least one of whether to reuse the TC-RNTI, an indication of a new TC-RNTI, an indication of a cell, of the unidirectional cell or the bidirectional cell, to use for the retransmission of the third RACH message, or an uplink grant for the retransmission of the third RACH message. The reception component 1002 may receive, based at least in part on transmitting a RACH msgA as the first RACH message in the bidirectional cell, an indicator to switch from a two-step RACH procedure to a four-step RACH procedure. The transmission component 1004 may transmit, based at least in part on receiving the indicator, a RACH msg3 as a third RACH message in the unidirectional cell.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A-7F. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, on a downlink carrier of a bidirectional cell having the downlink carrier and a first uplink carrier, configuration information. The reception component 1102 may receive, on the first uplink carrier of the bidirectional cell or a second uplink carrier of a co-located unidirectional cell, a first RACH message in accordance with the configuration information, wherein the bidirectional cell is associated with a first frequency range, and the unidirectional cell is associated with a second frequency range that is lower than the first frequency range.

The transmission component 1104 may transmit an SSB communication in the bidirectional cell, wherein each SSB beam, of a group of SSB beams for the SSB communication, is associated with one or more sets of ROs. The reception component 1102 may receive a retransmission of the first RACH message in a new determined set of ROs, wherein the determined set of ROs is associated with a first RO set, of the one or more sets of ROs, and the new determined set of ROs is associated with a second RO set, of the one or more sets of ROs, the first RO set being different than the second RO set. The transmission component 1104 may transmit, as a response to receiving the first RACH message, a second RACH message. The reception component 1102 may receive, based at least in part on transmitting the second RACH message, a third RACH message, wherein a configuration of the third RACH message is based at least in part on a configuration of the second RACH message. The reception component 1102 may receive a third RACH message.

The transmission component 1104 may transmit, based at least in part on receiving the third RACH message, DCI associated with triggering a retransmission of the third RACH message, wherein the DCI is scrambled using a TC-RNTI associated with a second RACH message. The transmission component 1104 may transmit an indication of one or more parameters to use for the retransmission of the RACH message, the one or more parameters including at least one of whether to reuse the TC-RNTI, an indication of a new TC-RNTI, an indication of a cell, of the unidirectional cell or the bidirectional cell, to use for the retransmission of the third RACH message, or an uplink grant for the retransmission of the third RACH message. The transmission component 1104 may transmit, based at least in part on receiving a RACH msgA as the first RACH message in the bidirectional cell, an indicator to switch from a two-step RACH procedure to a four-step RACH procedure. The reception component 1102 may receive, based at least in part on transmitting the indicator, a RACH msg3 as a third RACH message in the unidirectional cell.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, on a downlink carrier of a bidirectional cell having the downlink carrier and a first uplink carrier, configuration information; and transmitting, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range.

Aspect 2: The method of Aspect 1, further comprising: receiving a synchronization signal block (SSB) communication in the bidirectional cell, wherein each SSB beam, of a group of SSB beams for the SSB communication, is associated with one or more sets of RACH occasions (ROs).

Aspect 3: The method of Aspect 2, wherein the one or more sets of ROs includes at least one of: a first set of ROs associated with the bidirectional cell, a second set of ROs associated with the unidirectional cell, or a third set of ROs associated with both the bidirectional cell and the unidirectional cell.

Aspect 4: The method of Aspect 2, further comprising: selecting an SSB beam, from the group of SSB beams, as a selected SSB beam; and determining a set of ROs, of the one or more sets of ROs, as a determined set of ROs based at least in part on the selected SSB beam; and wherein transmitting the first RACH message comprises: transmitting the first RACH message in the determined set of ROs.

Aspect 5: The method of Aspect 4, wherein the first RACH message is a RACH msg1 or a RACH msgA.

Aspect 6: The method of Aspect 4, wherein determining the set of ROs comprises: determining a single RO to transmit the first RACH message in a single cell of the bidirectional cell or the unidirectional cell, or determining an RO pair to transmit the first RACH message, concurrently, on the bidirectional cell and the unidirectional cell.

Aspect 7: The method of Aspect 4, further comprising: determining another set of ROs, of the one or more sets of ROs, as a new determined set of ROs; and retransmitting the first RACH message in the other set of ROs, wherein the determined set of ROs is associated with a first RO set, of the one or more sets of ROs, and the new determined set of ROs is associated with a second RO set, of the one or more sets of ROs, the first RO set being different than the second RO set.

Aspect 8: The method of any of Aspects 1-7, further comprising: receiving, as a response to transmitting the first RACH message, a second RACH message.

Aspect 9: The method of Aspect 8, further comprising: transmitting, based at least in part on receiving the second RACH message, a third RACH message, wherein a configuration of the third RACH message is based at least in part on a configuration of the second RACH message.

Aspect 10: The method of Aspect 9, wherein a cell, of the unidirectional cell and the bidirectional cell, for transmitting the third RACH message is based at least in part on at least one of: an indicator in a payload of the second RACH message, a random access (RA) radio network temporary identifier (RNTI) (RA-RNTI) of the second RACH message, or a measurement of the first RACH message.

Aspect 11: The method of Aspect 9, wherein the second RACH message is associated with a random access (RA) radio network temporary identifier (RNTI) (RA-RNTI) that is based at least in part on the first RACH message.

Aspect 12: The method of Aspect 11, wherein the RA-RNTI is based at least in part on a mapping rule, the mapping rule including that the RA-RNTI is based at least in part on one of: a first RO, of an RO pair, associated with the bidirectional cell, a second RO, of the RO pair, associated with the unidirectional cell, the first RO or the second RO based at least in part on whether the RACH message is successfully decoded in the first RO or the second RO, an RO, of the first RO or the second RO, that is included in the RO pair and not another RO pair, or a mathematical operation applied to respective RA-RNTIs of the first RO and the second RO.

Aspect 13: The method of Aspect 12, wherein receiving the configuration information comprises: receiving an indication of the mapping rule in at least one of: a system information block, a master information block, or a synchronization signal block.

Aspect 14: The method of Aspect 8, wherein receiving the second RACH message comprises: receiving the second RACH message in a random access response (RAR) window, wherein the RAR window is based at least in part on a last symbol of the first RACH message as transmitted on the bidirectional cell and as transmitted on the unidirectional cell.

Aspect 15: The method of any of Aspects 1-14, further comprising: transmitting a third RACH message; receiving, based at least in part on transmitting the third RACH message, downlink control information (DCI) associated with triggering a retransmission of the third RACH message, wherein the DCI is scrambled using a temporary cell-specific (TC) radio network temporary identifier (RNTI) (TC-RNTI) associated with a second RACH message.

Aspect 16: The method of Aspect 15, wherein the DCI is a first format of DCI including an uplink grant, wherein the uplink grant is for the retransmission of the third RACH message.

Aspect 17: The method of Aspect 15, wherein the DCI is a second format of DCI scheduling a physical downlink shared channel (PDSCH), wherein the PDSCH includes an indication of the retransmission of the third RACH message.

Aspect 18: The method of Aspect 15, further comprising: receiving an indication of one or more parameters to use for the retransmission of the RACH message, the one or more parameters including at least one of: whether to reuse the TC-RNTI, an indication of a new TC-RNTI, an indication of a cell, of the unidirectional cell or the bidirectional cell, to use for the retransmission of the third RACH message, or an uplink grant for the retransmission of the third RACH message.

Aspect 19: The method of Aspect 15, wherein further comprising: retransmitting the third RACH message based at least in part on receiving the DCI.

Aspect 20: The method of Aspect 19, wherein a power control parameter for the retransmission of the third RACH message is based at least in part on at least one of: a transmit power of an initial transmission of the third RACH message, a reset transmit power control counter, or a retransmission transmit power control table entry.

Aspect 21: The method of Aspect 20, wherein the first RACH message and an initial transmission of the third RACH message occurred in the bidirectional cell, and wherein retransmitting the third RACH message further comprises retransmitting the third RACH message in the unidirectional cell.

Aspect 22: The method of any of Aspects 1-21, further comprising: receiving, based at least in part on transmitting a RACH msgA as the first RACH message in the bidirectional cell, an indicator to switch from a two-step RACH procedure to a four-step RACH procedure; and transmitting, based at least in part on receiving the indicator, a RACH msg3 as a third RACH message in the unidirectional cell.

Aspect 23: A method of wireless communication performed by a network node, comprising: transmitting, on a downlink carrier of a bidirectional cell having the downlink carrier and a first uplink carrier, configuration information; and receiving, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range.

Aspect 24: The method of Aspect 23, further comprising: transmitting a synchronization signal block (SSB) communication in the bidirectional cell, wherein each SSB beam, of a group of SSB beams for the SSB communication, is associated with one or more sets of RACH occasions (ROs).

Aspect 25: The method of Aspect 24, wherein the one or more sets of ROS includes at least one of: a first set of ROs associated with the bidirectional cell, a second set of ROs associated with the unidirectional cell, or a third set of ROs associated with both the bidirectional cell and the unidirectional cell.

Aspect 26: The method of Aspect 24, wherein receiving the first RACH message comprises: receiving the first RACH message in a determined set of ROs, the determined set of ROs being based at least in part on a selected SSB beam from the group of SSB beams.

Aspect 27: The method of Aspect 26, wherein the first RACH message is a RACH msg1 or a RACH msgA.

Aspect 28: The method of Aspect 26, wherein determined set of ROs comprises: a single RO to convey the first RACH message in a single cell of the bidirectional cell or the unidirectional cell, or an RO pair to convey the first RACH message, concurrently, on the bidirectional cell and the unidirectional cell.

Aspect 29: The method of Aspect 26, further comprising: receiving a retransmission of the first RACH message in a new determined set of ROs, wherein the determined set of ROs is associated with a first RO set, of the one or more sets of ROs, and the new determined set of ROs is associated with a second RO set, of the one or more sets of ROs, the first RO set being different than the second RO set.

Aspect 30: The method of any of Aspects 23-29, further comprising: transmitting, as a response to receiving the first RACH message, a second RACH message.

Aspect 31: The method of Aspect 30, further comprising: receiving, based at least in part on transmitting the second RACH message, a third RACH message, wherein a configuration of the third RACH message is based at least in part on a configuration of the second RACH message.

Aspect 32: The method of Aspect 31, wherein a cell, of the unidirectional cell and the bidirectional cell, for receiving the third RACH message is based at least in part on at least one of: an indicator in a payload of the second RACH message, a random access (RA) radio network temporary identifier (RNTI) (RA-RNTI) of the second RACH message, or a measurement of the first RACH message.

Aspect 33: The method of Aspect 31, wherein the second RACH message is associated with a random access (RA) radio network temporary identifier (RNTI) (RA-RNTI) that is based at least in part on the first RACH message.

Aspect 34: The method of Aspect 33, wherein the RA-RNTI is based at least in part on a mapping rule, the mapping rule including that the RA-RNTI is based at least in part on one of: a first RO, of an RO pair, associated with the bidirectional cell, a second RO, of the RO pair, associated with the unidirectional cell, the first RO or the second RO based at least in part on whether the RACH message is successfully decoded in the first RO or the second RO, an RO, of the first RO or the second RO, that is included in the RO pair and not another RO pair, or a mathematical operation applied to respective RA-RNTIs of the first RO and the second RO.

Aspect 35: The method of Aspect 34, wherein transmitting the configuration information comprises: transmitting an indication of the mapping rule in at least one of: a system information block, a master information block, or a synchronization signal block.

Aspect 36: The method of Aspect 30, wherein transmitting the second RACH message comprises: transmitting the second RACH message in a random access response (RAR) window, wherein the RAR window is based at least in part on a last symbol of the first RACH message as transmitted on the bidirectional cell and as transmitted on the unidirectional cell.

Aspect 37: The method of any of Aspects 23-36, further comprising: receiving a third RACH message; transmitting, based at least in part on receiving the third RACH message, downlink control information (DCI) associated with triggering a retransmission of the third RACH message, wherein the DCI is scrambled using a temporary cell-specific (TC) radio network temporary identifier (RNTI) (TC-RNTI) associated with a second RACH message.

Aspect 38: The method of Aspect 37, wherein the DCI is a first format of DCI including an uplink grant, wherein the uplink grant is for the retransmission of the third RACH message.

Aspect 39: The method of Aspect 37, wherein the DCI is a second format of DCI scheduling a physical downlink shared channel (PDSCH), wherein the PDSCH includes an indication of the retransmission of the third RACH message.

Aspect 40: The method of Aspect 37, further comprising: transmitting an indication of one or more parameters to use for the retransmission of the RACH message, the one or more parameters including at least one of: whether to reuse the TC-RNTI, an indication of a new TC-RNTI, an indication of a cell, of the unidirectional cell or the bidirectional cell, to use for the retransmission of the third RACH message, or an uplink grant for the retransmission of the third RACH message.

Aspect 41: The method of Aspect 37, wherein further comprising: receiving a retransmission of the third RACH message based at least in part on transmitting the DCI.

Aspect 42: The method of Aspect 41, wherein a power control parameter for the retransmission of the third RACH message is based at least in part on at least one of: a transmit power of an initial transmission of the third RACH message, a reset transmit power control counter, or a retransmission transmit power control table entry.

Aspect 43: The method of Aspect 42, wherein the first RACH message and an initial transmission of the third RACH message occurred in the bidirectional cell, and wherein receiving the retransmission of the third RACH message further comprises receiving the retransmission of the third RACH message in the unidirectional cell.

Aspect 44: The method of any of Aspects 23-43, further comprising: transmitting, based at least in part on receiving a RACH msgA as the first RACH message in the bidirectional cell, an indicator to switch from a two-step RACH procedure to a four-step RACH procedure; and receiving, based at least in part on transmitting the indicator, a RACH msg3 as a third RACH message in the unidirectional cell.

Aspect 45: An apparatus for wireless communication at a device, comprising a processor; memory coupled with the processor; and instructions stored in the memory and executable by the processor to cause the apparatus to perform the method of one or more of Aspects 1-44.

Aspect 46: A device for wireless communication, comprising a memory and one or more processors coupled to the memory, the one or more processors configured to perform the method of one or more of Aspects 1-44.

Aspect 47: An apparatus for wireless communication, comprising at least one means for performing the method of one or more of Aspects 1-44.

Aspect 48: A non-transitory computer-readable medium storing code for wireless communication, the code comprising instructions executable by a processor to perform the method of one or more of Aspects 1-44.

Aspect 49: A non-transitory computer-readable medium storing a set of instructions for wireless communication, the set of instructions comprising one or more instructions that, when executed by one or more processors of a device, cause the device to perform the method of one or more of Aspects 1-44.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a +a, a +a +a, a +a +b, a +a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, on a downlink carrier of a bidirectional cell having the downlink carrier and a first uplink carrier, configuration information; and
transmit, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range.

2. The UE of claim 1, wherein the one or more processors are further configured to:
receive a synchronization signal block (SSB) communication in the bidirectional cell,
wherein each SSB beam, of a group of SSB beams for the SSB communication, is associated with one or more sets of RACH occasions (ROs).

3. The UE of claim 2, wherein the one or more sets of ROs includes at least one of:
a first set of ROs associated with the bidirectional cell,
a second set of ROs associated with the unidirectional cell, or
a third set of ROs associated with both the bidirectional cell and the unidirectional cell.

4. The UE of claim 2, wherein the one or more processors are further configured to:
select an SSB beam, from the group of SSB beams, as a selected SSB beam; and
determine a set of ROs, of the one or more sets of ROs, as a determined set of ROs based at least in part on the selected SSB beam; and
wherein the one or more processors, to transmit the first RACH message, are configured to:
transmit the first RACH message in the determined set of ROs.

5. The UE of claim 4, wherein the first RACH message is a RACH msg1 or a RACH msgA.

6. The UE of claim 4, wherein the one or more processors, to determine the set of ROs, are configured to:
determine a single RO to transmit the first RACH message in a single cell of the bidirectional cell or the unidirectional cell, or
determine an RO pair to transmit the first RACH message, concurrently, on the bidirectional cell and the unidirectional cell.

7. The UE of claim 4, wherein the one or more processors are further configured to:
determine another set of ROs, of the one or more sets of ROs, as a new determined set of ROs; and
retransmit the first RACH message in the other set of ROS,
wherein the determined set of ROs is associated with a first RO set, of the one or more sets of ROs, and the new determined set of ROs is associated with a second RO set, of the one or more sets of ROs, the first RO set being different than the second RO set.

8. The UE of claim 1, wherein the one or more processors are further configured to:
receive, as a response to transmitting the first RACH message, a second RACH message.

9. The UE of claim 8, wherein the one or more processors are further configured to:
transmit, based at least in part on receiving the second RACH message, a third RACH message,
wherein a configuration of the third RACH message is based at least in part on a configuration of the second RACH message.

10. The UE of claim 9, wherein a cell, of the unidirectional cell and the bidirectional cell, for transmitting the third RACH message is based at least in part on at least one of:
an indicator in a payload of the second RACH message,
a random access (RA) radio network temporary identifier (RNTI) (RA-RNTI) of the second RACH message, or
a measurement of the first RACH message.

11. The UE of claim 9, wherein the second RACH message is associated with a random access (RA) radio network temporary identifier (RNTI) (RA-RNTI) that is based at least in part on the first RACH message.

12. The UE of claim 11, wherein the RA-RNTI is based at least in part on a mapping rule, the mapping rule including that the RA-RNTI is based at least in part on one of:
a first RO, of an RO pair, associated with the bidirectional cell,
a second RO, of the RO pair, associated with the unidirectional cell,
the first RO or the second RO based at least in part on whether the RACH message is successfully decoded in the first RO or the second RO,
an RO, of the first RO or the second RO, that is included in the RO pair and not another RO pair, or
a mathematical operation applied to respective RA-RNTIs of the first RO and the second RO.

13. The UE of claim 12, wherein the one or more processors, to receive the configuration information, are configured to:
receive an indication of the mapping rule in at least one of:
a system information block,
a master information block, or
a synchronization signal block.

14. The UE of claim 8, wherein the one or more processors, to receive the second RACH message, are configured to:
receive the second RACH message in a random access response (RAR) window,
wherein the RAR window is based at least in part on a last symbol of the first RACH message as transmitted on the bidirectional cell and as transmitted on the unidirectional cell.

15. The UE of claim 1, wherein the one or more processors are further configured to:
transmit a third RACH message; and
receive, based at least in part on transmitting the third RACH message, downlink control information (DCI) associated with triggering a retransmission of the third RACH message,
wherein the DCI is scrambled using a temporary cell-specific (TC) radio network temporary identifier (RNTI) (TC-RNTI) associated with a second RACH message.

16. The UE of claim 15, wherein the DCI is a first format of DCI including an uplink grant,
wherein the uplink grant is for the retransmission of the third RACH message.

17. The UE of claim 15, wherein the DCI is a second format of DCI scheduling a physical downlink shared channel (PDSCH),
wherein the PDSCH includes an indication of the retransmission of the third RACH message.

18. The UE of claim 15, wherein the one or more processors are further configured to:
receive an indication of one or more parameters to use for the retransmission of the RACH message, the one or more parameters including at least one of:
whether to reuse the TC-RNTI,
an indication of a new TC-RNTI,
an indication of a cell, of the unidirectional cell or the bidirectional cell, to use for the retransmission of the third RACH message, or
an uplink grant for the retransmission of the third RACH message.

19-22. (canceled)

23. A network node for wireless communication, comprising:
a memory; and
one or more processors, coupled to the memory, configured to:
transmit, on a downlink carrier of a bidirectional cell having the downlink carrier and a first uplink carrier, configuration information; and
receive, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range.

24-28. (canceled)

29. A method of wireless communication performed by a user equipment (UE), comprising:
receiving, on a downlink carrier of a bidirectional cell having the downlink carrier and a first uplink carrier, configuration information; and
transmitting, on the first uplink carrier of the bidirectional cell or a second uplink carrier of a co-located unidirectional cell, a first random access channel (RACH) message in accordance with the configuration information, wherein the bidirectional cell is associated with a first frequency range, and the unidirectional cell is associated with a second frequency range that is lower than the first frequency range.

30. (canceled)
